(19) United States
(12) Patent Application Publication
(10) Pub. No.: US 2007/0274885 A1
(43) Pub. Date: Nov. 29, 2007

(54) Fractal-Forming Alkylketene Dimers For Integral Membrane Protein Crystal Growth

(76) Inventor: Michael Hanson, Emeryville, CA (US)

Correspondence Address: SAGRES DISCOVERY INC.;INTELLECTUAL PROPERTY - R440, P.O. BOX 8097, EMERYVILLE, CA, 94662-8097, US

(21) Appl. No.: 10/574,033

(22) PCT Filed: Sep. 27, 2004
(86) PCT No.: PCT/US04/31739

§ 371 Date: Mar. 21, 2007

Related U.S. Application Data
(60) Provisional application No. 60/506,125, filed on Sep. 25, 2003.

(51) Int. Cl. B01D 9/00

(52) U.S. Cl. 422/245.1

(57) ABSTRACT

This invention provides a device for promoting crystallization of integral membrane proteins using a surface of alkylketene dimers doped with a nucleating compound. A coating that enhances crystallization of integral membrane proteins in the presence of detergent is provided. In another aspect of the invention methods of creating a surface of alkylketene dimers doped with a nucleating compound to promote crystallization of integral membrane proteins are provided. In another aspect of the invention methods of crystallizing integral membrane proteins using surfaces coated with alkylketene dimers doped with a nucleating compound are provided.

### FIELD OF THE INVENTION

This invention relates generally to crystallography and growth of protein crystals. More particularly, this invention relates to a device and method for promoting crystal growth of integral membrane proteins.

### BACKGROUND OF THE INVENTION

Determining protein structure is an essential step in modern drug discovery and molecular biology. Using X-ray or electron crystallographic techniques, the three-dimensional structures of biological macromolecules, such as proteins, nucleic acids, and their various complexes, can be determined at practically atomic-level resolution from diffraction data. Such structural information furthers our understanding of important biological processes and can also guide drug design.

The first step in determining the crystal structure of a target macromolecule is to grow large, well-diffracting crystals of the macromolecule. Techniques for collecting and analyzing diffraction data have become more rapid and automated because of the importance of structural information to drug development. However, growing the protein crystals has become a rate-limiting step in the process of determining structure. Traditional methods of growing crystals have proven unsuccessful or inefficient when applied to many biological macromolecules. In particular, integral membrane proteins are difficult to process by automated techniques because they require the presence of detergents and lipid molecules in the crystal growth medium.

Vapor diffusion is the most widely used technique for crystallization of proteins. In vapor diffusion, a drop containing the macromolecule, stabilizing buffers, percipients and crystallization aids is allowed to equilibrate in a closed system exposed to a larger reservoir. The reservoir usually contains the same components as the crystallization drop (except the macromolecule) but at a higher concentration so that water preferentially evaporates from the drop. The drop is kept separate from the reservoir of crystallization solvent either by hanging the drop from a glass cover slip (the hanging drop method) or by sitting the drop on a pedestal above the level of the solvent in the reservoir (the sitting drop method). Over time, the crystallization drop and the reservoir solutions equilibrate via vapor diffusion. Supersaturating concentrations of the macromolecule are achieved, resulting in crystallization of the macromolecule sample in the drop.

Membrane proteins are typically very hydrophobic, and therefore difficult to crystallize. Membrane proteins also tend to aggregate amorphously instead of forming well-ordered three-dimensional crystals. Techniques such as Lipidic Cubic Phase (LCP) crystallization have been successful in crystallizing integral membrane proteins by mixing membrane protein samples with a lipid to form a gel-like emulsion of protein and lipid (Landau, E M and J P Rosenbusch, PNAS, 1996, 93:14532-14535). The lipid in this emulsion forms a cubic, three-dimensional, lattice in which the hydrophobic membrane proteins can form three-dimensional crystals.

Thus, crystallization of integral membrane proteins is complicated by the need for detergent and lipid molecules in the crystal growth medium. Although automation technology has enabled significant growth in high-throughput crystallization of biomolecules, the presence of detergents and lipids prevents most high-throughput techniques. Rapid crystallization screening is typically done using the sitting drop technique to form crystals in arrays on surfaces such as plastics or glass. Attempts to use high-throughput crystallization technology for integral membrane proteins has led to disappointing results because the detergent that is necessary to maintain the membrane proteins in a soluble state, as well as included lipids, significantly reduces the surface tension of the crystallization drop. The drop often completely coats the plastic surface, inhibiting crystallization.

Further, it is desirable that the crystallization drop only minimally contact the surface on which it rests because the surface and liquid interface has been implicated as a major source of randomness in crystal growth. In particular, the surface/liquid interface contributes a good deal of heterogeneity due to dust accumulation and other variations in the surface. Thus, better crystals result with less contact between the drop and the surface.

Alkylketene dimers (AKD) have been suggested as a possible crystallization surface for soluble macromolecules (Shibuichi, et al, 1996, J. Phys. Chem. 50:19512-17) but not for integral membrane proteins. The ability of alkylketene dimers to impart water resistance is well known in the paper industry, where it is used as an anti-wetting agent. Because of this water-resistance property, Fujii and Hirayama used an alkylketene dimer coated surface to crystallize the soluble protein lysozyme (I. Fujii and N. Hirayama, Acta Crystallogr D. Biol. Crystallogr. 1999, 55:1247-49). Alkylketene dimers spontaneously form fractal structures when cooled. Fujii and Hirayama showed that these fractal surfaces increase the surface contact angle of aqueous drops, thus minimizing contact between the drop and the surface.

However, alkylketene dimer surfaces have not proven consistently effective for crystallizing integral membrane proteins solubilized in detergent and lipid. Experiments with alkylketene dimer-coated surfaces and detergents show great variability preventing surface wetting and promoting crystallization when detergent is present in the crystallization drop. This variability makes pure alkylketene dimer coatings impractical for most crystallization purposes, including high-throughput processes. Moreover, the use of alkylketene dimer coatings for crystallizing even soluble biomolecules is more expensive than routine siliconization.

Thus, there is a need to create surfaces or surface coatings which minimize the interaction between the crystallization drop and the surface on which the drop rests. More specifically, there is a need for surfaces that can be used to create high-quality crystals of integral membrane proteins despite the presence of surface-active detergents and lipids.

Accordingly, the present invention is directed at the creation and use of a surface comprised of or coated with alkylketene dimers doped with a nucleating agent in order to enhance crystallization of internal membrane proteins.

### SUMMARY OF THE INVENTION

One aspect of the present invention provides a useful device for promoting the crystallization of integral membrane proteins including a surface and a coating of alkylketene dimers that has been doped with a nucleating compound. In some embodiments of this invention, the nucleating compound is a dialkyl ketone.

Alternative embodiments of the invention contemplate using stearoylketene dimers as the alkylketene dimers. Distearoyl ketone is also contemplated as a nucleating compound.

Another aspect of this invention provides a method of preparing a surface to promote crystallization of integral membrane proteins by coating the surface with alkylketene dimers doped with a nucleating compound.

Alternative embodiments of this method contemplate using stearoylketene dimers as the alkylketen dimers. The use of distearoyl ketone is also contemplated as a nucleating compound.

In some embodiments of this invention, the coating is applied by vapor deposition.

Another aspect of this invention provides a method of crystallizing integral membrane proteins by applying a droplet solution containing integral membrane proteins to a surface coated with alkylketene dimers doped with a nucleating compound.

Alternative embodiments of the invention contemplate using stearoylketene dimers as the alkylketene dimers. Distearoyl ketone is also contemplated as a nucleating compound. In some variations, the droplet containing integral membrane proteins is applied to the top of the coated surface as a sitting drop. In other variations, the droplet containing the integral membrane proteins is applied to the coated surface as a hanging drop.

### BRIEF DESCRIPTION OF THE DRAWINGS

FIG. 1 shows compound 1, alkyl ketene dimer (AKD)

FIG. 2 illustrates 5 μl drops of water on various surfaces. The upper row (A-C) shows a view looking down on the drop, and the lower row (D-F) shows side views of the drop. Untreated glass is shown on the left (A,D), siliconized glass is shown in the middle (B,E), and glass coated with stearoylketene dimers doped with distearoyl ketone is shown to the right (C,F).

FIG. 3 illustrates 5 μl drops of water with 0.05% DDM detergent on various surfaces. The upper row (A-C) shows a view looking down on the drop, and the lower row (D-F) shows side views of the drop. Untreated glass is shown on the left (A,D), siliconized glass is shown in the middle (B,E), and glass coated with stearoylketene dimers doped with distearoyl ketone is shown to the right (C,F).

FIG. 4 shows compound 2, dialkyl ketone (DAK)

FIG. 5 shows the diffraction pattern of an SKD fractal surface.

### DETAILED DESCRIPTION OF THE INVENTION

The following examples are intended to convey certain principles of the invention. These examples are not intended to limit the scope of the claims to any particular example. It is understood that the claims are to be given their broadest reasonable interpretation in view of the description herein, any prior art, and the knowledge of those of ordinary skill in the field. Those skilled in the art will readily appreciate that many variations may be derived using the following description.

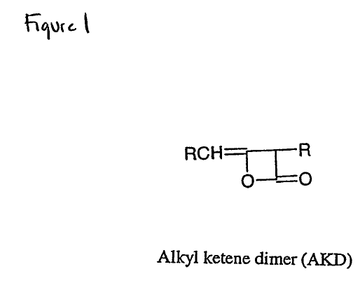

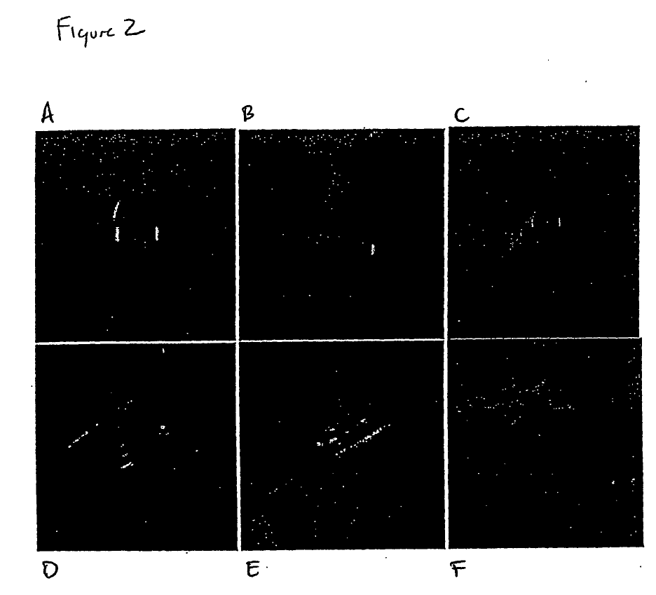

FIG. 1 shows a diagram of the molecular structure of an alkyl ketene dimer. Alkylketene dimers can be heated and formed into a surface. Further, alkylketene dimer surfaces spontaneously form fractal structures when cooled. These fractal surfaces have a high degree of surface roughness resulting in super-water-repellent properties. Contact angle is one indicator of water repellency or wettability. The increased surface roughness results in a higher contact angle between an aqueous drop and the fractal surface on which the drop rests. The greater the surface contact angle, the more spherical the drop is on the surface and the less contact there is between the drop and the surface. This effect is illustrated in FIG. 2.

FIG. 2 shows 5 μl drops of water that have been placed on various surfaces. On untreated glass, the surface contact angle is less than 90 degrees, as illustrated by FIGS. 2A and 2D. On glass that has been coated with silicon (siliconized), the surface contact angle of the water is greater than 140 degrees, as illustrated by FIGS. 2B and 2E. This is comparable to glass that has been coated with the alkylketene dimer, distearoyl ketene. FIGS. 2C and 2F illustrate the high contact angle on the distearoyl ketene dimer-coated surface. Both siliconized and alkylketene dimer-coated surfaces have high contact angles with drops of pure water.

As described above, contact angle is an indicator of a surfaces ability to promote crystallization of macromolecules such as proteins. The greater the contact angle, the more spherical the droplet, thereby minimizing interfering effects from the surface/liquid interface. Thus, higher quality crystals can be grown.

This relationship between contact angle and surface is particularly critical in the emerging field of high-throughput crystallization. Thus, high-throughput crystallization is a good example of an application for this invention. Typically, high-throughput techniques use sitting drop vapor diffusion formats in which the drop (or drops) of fluid containing the macromolecules to be crystallized sit on top of a surface. Most often a plastic, rather than siliconized glass, is preferable as a crystallization surface. Attempts to use high-throughput crystallization technology for integral membrane proteins has led to disappointing results due to the required presence of detergent in the aqueous medium. Detergents and lipids are necessary for crystallization of integral membrane proteins because detergent micelles are required to maintain the macromolecule in a soluble state and lipids are required to prevent dilapidation of the macromolecule by mass action.

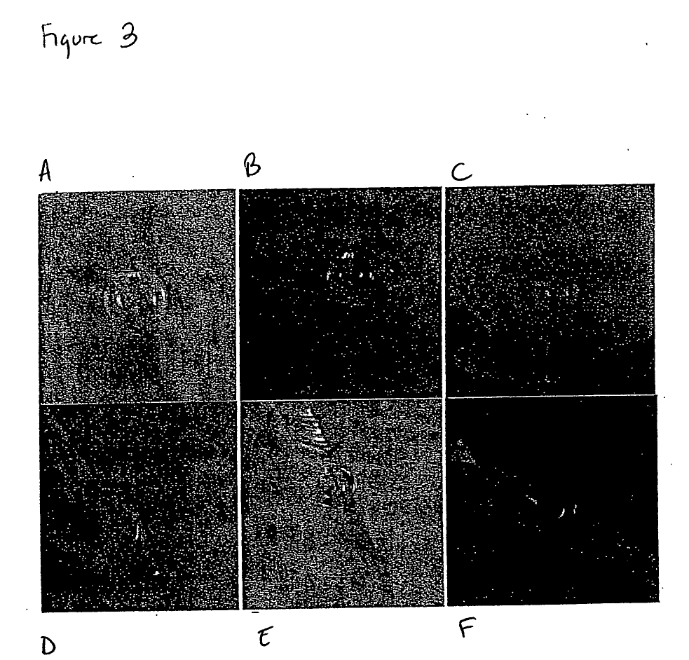

The presence of lipid and detergent also reduces the surface tension of the crystallization drop, dramatically decreasing the contact angle between the drop and the surface. This is illustrated in FIG. 3. FIG. 3 shows 5 μl drops of water containing 0.05% dodecylmaltoside (DDM) detergent placed on various surfaces. On untreated glass, the surface contact angle is less than 90 degrees, as illustrated by FIGS. 3A and 3D. On glass that has been coated with silicon (siliconized), the surface contact angle of the water is also less than 90 degrees, as illustrated by FIGS. 3B and 3E. However, on glass coated with an alkylketene dimer that has been doped with a dialkyl ketone (stearoylketene dimer doped with distearoyl ketene), the surface angle is greater than 150 degrees. FIGS. 3C and 3F illustrate the high contact angle on the distearoyl ketene dimer-coated surface.

Thus, alkylketene dimers can reduce the wettability and thereby increase the contact angle of the crystallization drop even when using detergent. In particular, stearoylketene dimer is an alkylketene dimer that promotes a reduced surface wettability in the presence of detergent at or above the critical micelle concentration. However, pure alkylketene dimer coatings alone are insufficient. A highly pure alkylketene dimer coating exhibits too much variability in the fractal surface. This variation least to inconsistent wettability in the presence of detergent.

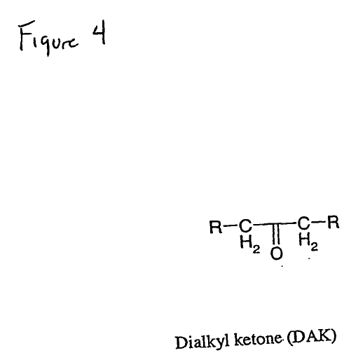

When using detergents, consistent super-water-repellent properties of alkylketene dimers are achieved only when modifications in the composition of the stearoylketene dimer mixture are made. Thus, the alkylketene dimer coating should be “doped” with some modifying compound to achieve consistent results with detergent-containing drops. In experiments with stearoylketene dimer coatings, the variability of surface wettability (contact angle) of drops containing detergent was traced to the variable presence of small amounts of distearoyl ketone impurity in the stearoylketene dimer sample. Distearoyl ketone forms as a hydrolysis product of stearoylketene dimer; repeated exposure of liquid stearoylketene dimer to the atmosphere increases the relative proportion of distearoyl ketone. FIG. 4 shows a molecular model of a dialkyl ketone. Distearoyl ketone is a form of dialkyl ketone. The proportion of distearoyl ketone and stearoylketene dimer alters the surface wettability and resulting contact angle.

The exact cause of the doping effect is unknown. We hypothesize that a more regular fractal surface pattern results from the higher melting temperature of distearoyl ketone contaminant relative to stearoylketene dimer. Thus, the distearoyl ketone acts as a nucleation point for the formation of the stearoylketene dimer fractal structure. By increasing the relative percentage of distearoyl ketone, the relative number of nucleation points are increased, which in turn increases the overall complexity of the resulting surface due to the eventual mixing of many different fractal-forming growth patterns evolving from the multiple nucleation points. Regardless of the cause, this suggests that an optimum distearoyl ketone/stearoylketene dimer ratio may exist for different applications, and possibly for each type of integral membrane protein crystallized, since the complexity of the surface may promote protein crystal nucleation and ordered growth.

The alkylketene dimer mixture may be doped with any additional compounds that alter the complexity of the resulting surface. For instance, a compound with an altered alkyl chain length such as oleoylketene dimer could be introduced into the mixture to selectively alter fractal growth patterns, thereby attenuating the complexity of the surface.

This invention contemplates using a mixture of alkylketene dimers that has been doped with a nucleating compound to create a surface on which crystals of integral membrane proteins can be grown. As described, the ratio of dimer and nucleating compound (or potentially compounds) can be determined for any particular application. This invention also contemplates creating surfaces which vary the ratio of alkylketene dimer and nucleating compound across the surface. Such a surface would be helpful in optimizing the ratio when crystallizing different macromolecules. Any form of alkylketene dimer could be used with this invention, in conjunction with any nucleating compound capable of altering the fractal pattern of the alkylketene dimer surface. Stearoylketene dimer doped with distearoyl ketone is a specific example of an alkylketene dimer and nucleating compound contemplated by this invention.

A coating of alkylketene dimer doped with a nucleating compound can be applied to virtually any surface to create a crystallization surface. For example, plastic or glass slides could be coated. It may be desirably to apply the coating in as thin a layer as possibly. Because typical doped alkylketene dimer coatings are opaque, thinner coatings may simplify directly visualizing crystal growth. Alternatively, coated slides with potential crystal-yielding drops could be screened by x-ray diffraction. After a suitable growth period, the crystal growth array can be flash frozen in liquid nitrogen and screened en mass for crystal growth by assessing the ability of each crystal growth drop to diffract x-rays. In this way, many conditions for crystal growth could be screened in parallel.

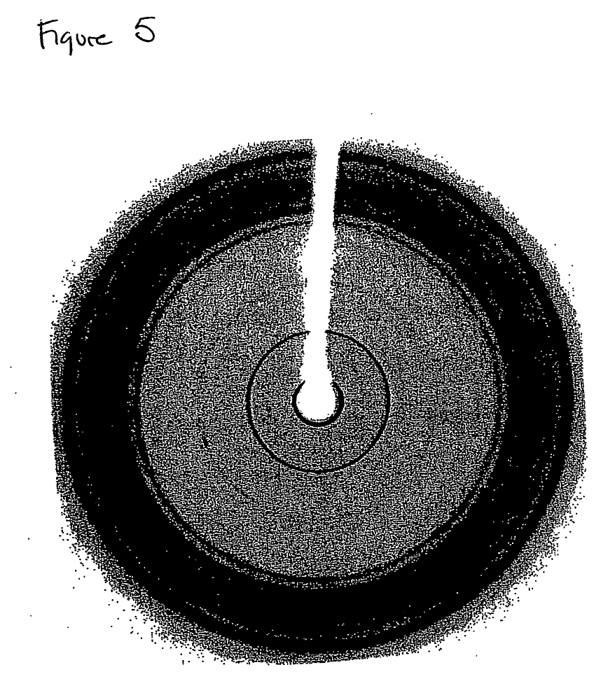

Screening crystals while they are still on the alkylketene dimer surface does complicate the analysis, however. This technique requires that the x-ray diffraction pattern of the alkylketene dimer factal surface be deconvolved from the x-ray diffraction pattern produced by the protein crystal. FIG. 5 shows the diffraction pattern of the stearoylketene dimer. Although differently-oriented protein crystals would complicate such an analysis, a highly focused x-ray beam would eliminate this potential complication.

Alkylketene dimers doped with a nucleating compound can be coated to surfaces by many different methods. Preliminary tests were made using stearoylketene dimer doped with distearoyl ketene. The stearoylketene dimer/distearoyl ketene mixture was first heated past its melting point, and then the liquid was transferred to a solid surface and allowed to cool. Different thicknesses of doped alkylketene dimers are possible. This invention contemplates using a vapor chamber to uniformly apply a layer or doped alkylketene dimer to a surface.

This invention is not limited to the sitting drop vapor diffusion method of crystal growth. Although doped alkylketene dimer surfaces are useful for high-throughput crystallization screening using the sitting drop crystallization format, these surfaces may also be useful in alternate conformations. Other conformations include sandwich drop and hanging drop vapor diffusion.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

I claim:

1. A device for promoting crystallization of integral membrane proteins, comprising:
a surface; and
a coating of alkylketene dimers doped with a nucleating compound on said surface.

2. The device of claim 1 where said alkylketene dimers comprises stearoylketene dimers.

3. The device of claim 1 where said nucleating compound is a dialkyl ketone.

4. The device of claim 1 where said nucleating compound is a distearoyl ketone.

5. A method of preparing a surface to promote crystallization of integral membrane proteins, comprising:
coating a surface with an alkylketene dimer doped with a nucleating compound.

6. The method of claim 5 where said alkylketene dimers comprises a stearoylketene dimer.

7. The method of claim 5 where said nucleating compound is a dialkyl ketone.

8. The method of claim 5 where said nucleating compound is a distearoyl ketone.

9. The method of claim 5 where said coating is applied by a process comprising vapor deposition.

10. A method of crystallizing integral membrane proteins, comprising:
applying a droplet of integral membrane proteins in solution to a surface coated with alkylketene dimers doped with a nucleating compound.

11. The method of claim 10 where said applied droplet is applied on top of said coated surface as a sitting drop.

12. The method of claim 10 where said applied droplet is applied to said coated surface as a hanging drop or a sandwich drop.
